(19) United States
(12) Patent Application Publication
(10) Pub. No.: US 2024/0216833 A1
(43) Pub. Date: Jul. 4, 2024

(54) VAPOR CHAMBER DEGASSING TUBE STRUCTURE AND MANUFACTURING METHOD THEREOF

(71) Applicant: TAIWAN MICROLOOPS CORP., New taipei City (TW)

(72) Inventor: Chun-Hung LIN, New Taipei City (TW)

(21) Appl. No.: 18/207,120

(22) Filed: Jun. 7, 2023

(30) Foreign Application Priority Data
Dec. 28, 2022 (TW) 111150425

(51) Int. Cl. B01D 19/00; B01D 61/36; B01D 63/02; B01D 69/06

(52) U.S. Cl. CPC B01D 19/0031; B01D 61/366; B01D 63/0221; B01D 69/06; B01D 2313/23

(57) ABSTRACT

A degassing tube includes a first plate, a second plate and a degassing tube. The first plate has a recess portion and a flange surrounding the recess portion. The flange has a first side and a second side opposite to the first side. A tube connector is disposed protrusively from the second side and located on the flange. The second plate covers the first plate. The degassing tube is disposed in the tube connector. The tube connector is formed with a degassing opening indented from the first side. The degassing opening has a maximum width defined in the tube connector and a minimum width defined on the first side. The minimum width is less than the maximum width for making the degassing tube tightly connected in the tube connector.

### BACKGROUND

### Technical Field

The disclosure relates to a heat conduction element, particularly to a vapor chamber degassing tube structure and a manufacturing method thereof.

### Related Art

A vapor chamber is a vacuum chamber with a micro structure such as a wick. In general manufacturing, to vacuum the chamber, a degassing tube (also known as “mouse tail tube”) communicating with the chamber is usually reserved, so that the chamber can be degassed or vacuumed through the degassing tube. After that, the degassing tube is sealed to make the chamber of the vapor chamber vacuumed.

However, because related-art vapor chambers are required to be more compact, the size of the degassing tube must be reduced correspondingly. Under the condition, a method of combining an upper plate and a lower plate to clamp a degassing tube is easy to be made, but more solder needs to be filled between the plates and the degassing tube for sealing. Thus, the control of solder is difficult, and excessive solder may infiltrate the chamber to damage the wick structure or spill from the plates to affect the appearance of product.

In view of this, the inventors have devoted themselves to the above-mentioned related art, researched intensively and cooperated with the application of science to try to solve the above-mentioned problems. Finally, the invention which is reasonable and effective to overcome the above drawbacks is provided.

### SUMMARY

An object of the disclosure is to provide a vapor chamber degassing tube structure and a manufacturing method thereof, which may reduce a gap between the plate of vapor chamber and the degassing tube to make the degassing tube be tightly connected without filling additional material.

To accomplish the above object, the disclosure provides a vapor chamber degassing tube structure, which includes a first plate, a second plate and a degassing tube. The first plate has a recess portion and a flange surrounding the recess portion. The recess portion is formed with a receiving space. The flange has a first side facing the same direction as the receiving space and a second side opposite to the first side. The flange is formed with a tube connector arched from the second side. The second plate covers the recess portion of the first plate and is connected with the flange. The degassing tube is disposed in the tube connector. The tube connector is formed with a degassing opening indented from the first side. The degassing opening has a maximum width formed in the tube connector and a minimum width formed on the first side in a shrunk manner. The minimum width is less than the maximum width.

To accomplish the above object, the disclosure provides a manufacturing method of a vapor chamber degassing tube structure, which includes the steps of:
a) preparing a first plate with a degassing opening of a vapor chamber, wherein the first plate has a recess portion and a flange surrounding the recess portion, the flange has a first side and a second side opposite to the first side, and the degassing opening is formed on the flange and indented from the first side; and
b) using a mold to press the degassing opening which is located at a periphery of the flange to make the degassing opening taper toward the first side.

### BRIEF DESCRIPTION OF THE DRAWINGS

FIG. 1 is an exploded schematic view of the disclosure:

FIG. 2 is a schematic plan view of the disclosure:

FIG. 3 is a partially cross-sectional view along line 3-3 in FIG. 2;

FIG. 4 is a partially cross-sectional view along line 4-4 in FIG. 2:

FIG. 5 is a schematic view of action of the manufacturing method of the disclosure:

FIG. 6 is another schematic view of action of the manufacturing method of the disclosure: and

FIG. 7 is a flowchart of the manufacturing method of the disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

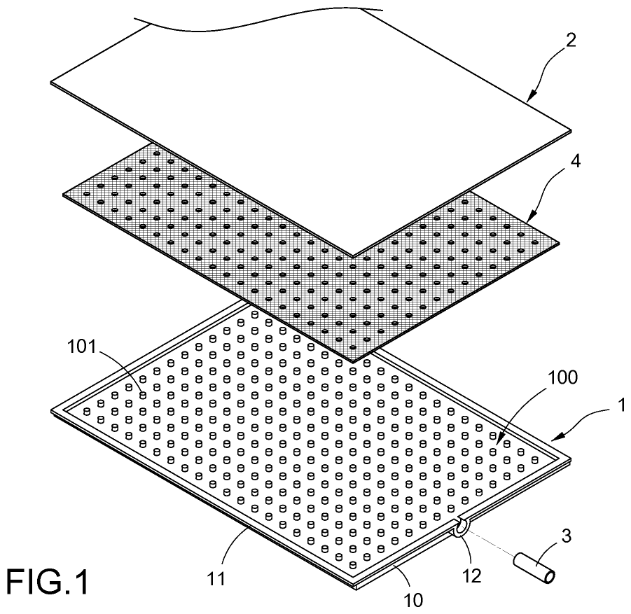

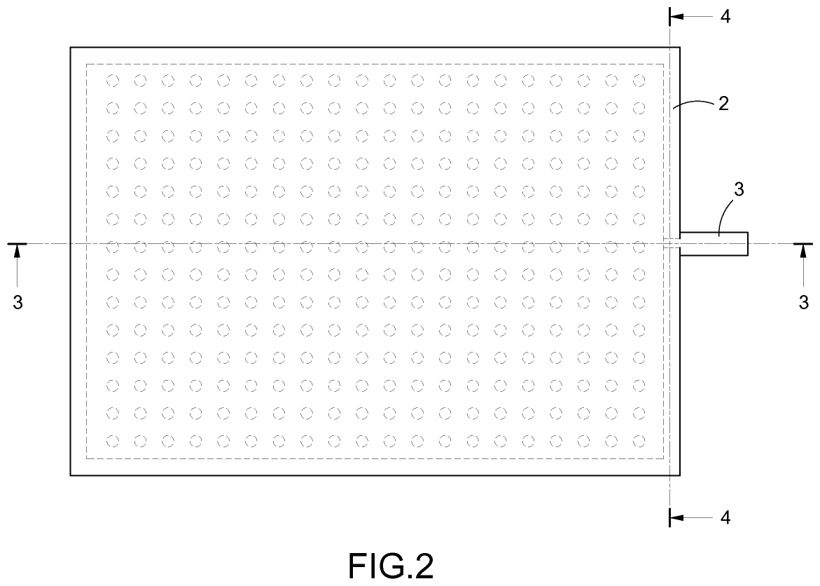

Please refer to FIGS. 1 and 2 which are an exploded schematic view and a schematic plan view of the disclosure, respectively. The disclosure provides a vapor chamber degassing tube structure and a manufacturing method thereof. The vapor chamber degassing tube structure includes a first plate 1, a second plate 2 covering the first plate 1 and a degassing tube 3 disposed between outer edges of the first plate 1 and the second plate 2. A wick structure 4 may be further disposed inside the first plate 1 and the second plate 2.

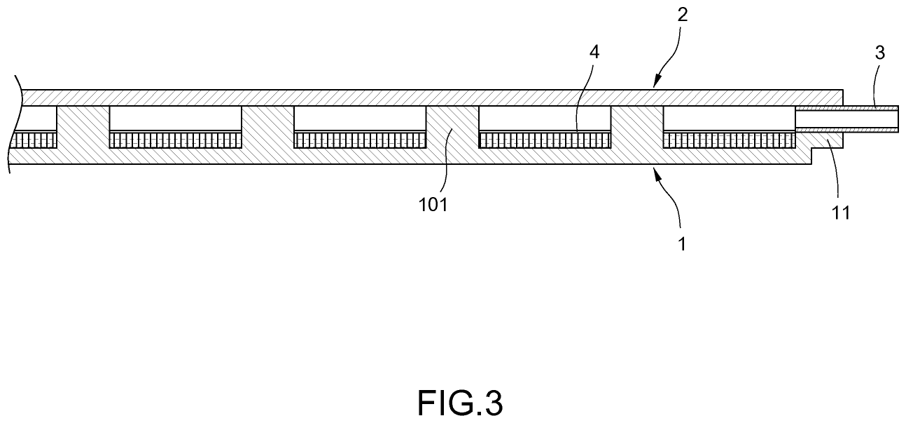

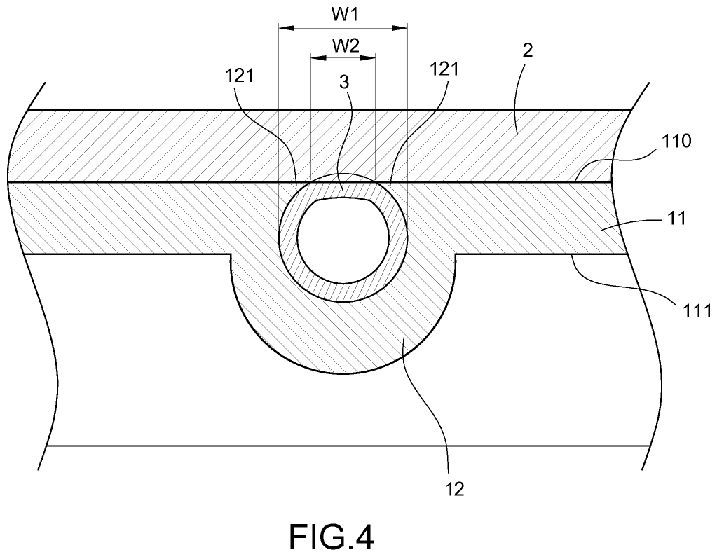

The first plate 1 has a recess portion 10 and a flange 11 surrounding the recess portion 10. As shown in FIGS. 2 and 3, the recess portion 10 is indented from a first side 110 of the flange 11 to form a receiving space 100, so that multiple support structures 101 are disposed spacedly in the receiving space 100. As a result, the receiving space 100 may form a chamber inside the vapor chamber after the first plate 1 and the second plate 2 being connected to each other. As shown in FIGS. 2 and 4, the flange 11 has the first side 110 facing the same direction as the receiving space 100 and a second side 111 opposite to the first side 110. The flange 11 is formed with a tube connector 12 arched from the second side 111. The tube connector 12 is used for disposing the degassing tube 3.

Please refer to FIGS. 1-3. The second plate 2 covers the recess portion 10 of the first plate 1 and is connected with the flange 11. The support structures 101 disposed in the receiving space 100 of the first plate 1 may support on the second plate 2 to prevent the second plate 2 from denting due to degassing or vacuuming, and prevent affecting the flatness of the outer surface of the vapor chamber and the volume inside the chamber. In the shown embodiment of the disclosure, the second plate 2 may be a flat plate with a flat inner surface and a flat outer surface.

The degassing tube 3 is disposed in the tube connector 12 of the first plate 1, so that the degassing tube 3 is clamped between the first plate 1 and the second plate 2 after the second plate 2 covers the first plate 1. In addition, the degassing tube 3 is a hollow tubular body before the degassing tube 3 is degassed or vacuumed. After above process is completed, the degassing tube 3 may be sealed by pressing or filling solder into the inside thereof.

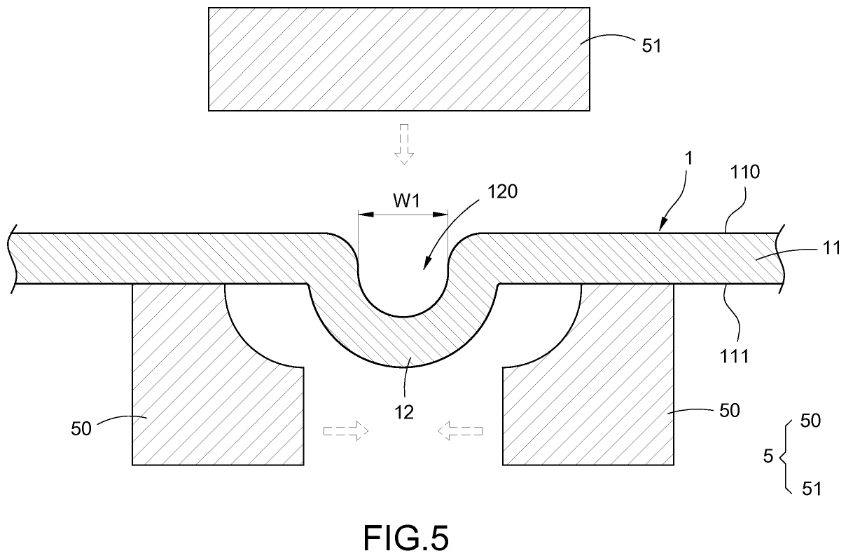

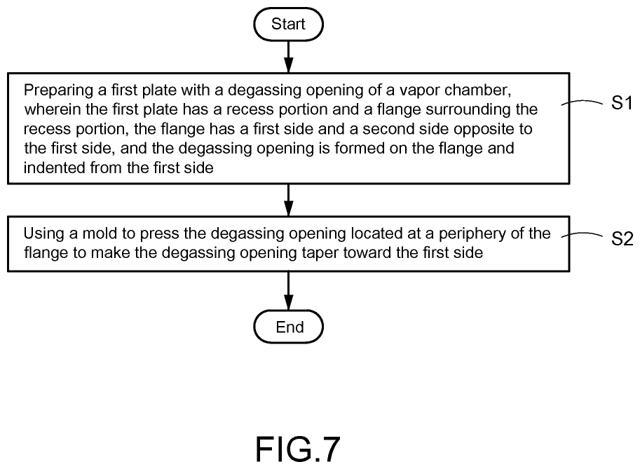

Please further refer to FIGS. 5-7. The manufacturing method of the disclosure starts with step S1 in FIG. 7: preparing a first plate 1 with a degassing opening 120 of a vapor chamber. The degassing opening 120 is formed on the tube connector 12 and indented inward from the first side 110 of the flange 11. In detail, the degassing opening 120 may be formed by stamping the flange 11 of the first plate 1. As shown in FIG. 5, a maximum width W1 of the degassing opening 120, which is formed on the tube connector 12, may substantially match the outer diameter of the degassing tube 3. Next, step S2 in FIG. 7: using a mold 5 to press the degassing opening 120 which is located at a periphery (i.e., the tube connector 12) of the flange 11. As shown in FIG. 5, the mold 5 may have two pressing mold blocks 50 and a support mold block 51. The two pressing mold blocks 50 may separately press the tube connector 12 from two sides of the first plate 1 and the support mold block 51 support the flange 11 of the first plate 1. In detail, the support mold block 51 may be omitted if the first plate 1 is flatly attached on a surface of a working platform of the mold 5 with the first side 110 of the flange 11.

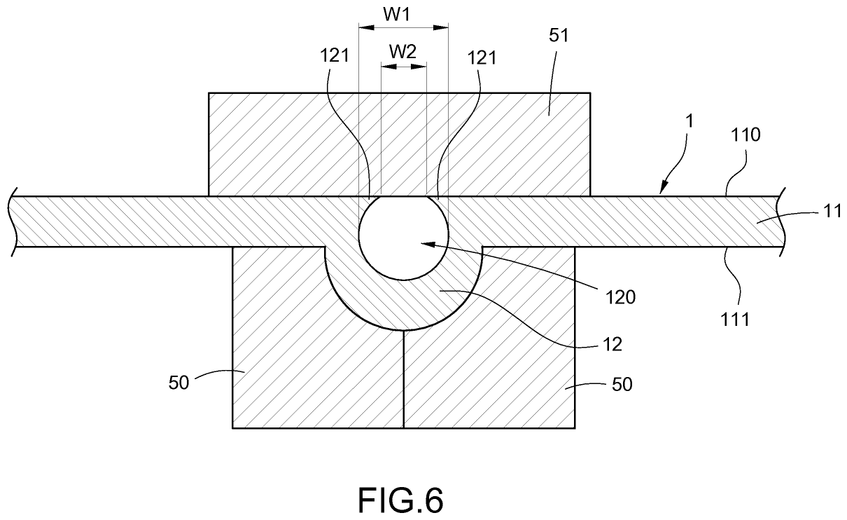

Next, as shown in FIG. 6, after the tube connector 12 is pressed by the two pressing mold blocks 50, the degassing opening 120 is inward shrunk and the first side 110 of the flange 11 is formed with two opposite shrunk portions 121. A minimum width W2 is formed between the two shrunk portions 121. The minimum width W2 is less than the maximum width W1. Accordingly, as shown in FIG. 4, the shrunk degassing opening 120 may be inserted by the degassing tube 3, and then the second plate 2 covers the first plate 1 to make the degassing tube 3 be tightly connected in the tube connector 12 and reduce the gap therebetween without filling additional material.

Therefore, by the above structure, the vapor chamber degassing tube structure and the manufacturing method thereof of the disclosure may be obtained.

While this disclosure has been described by means of specific embodiments, numerous modifications and variations could be made thereto by those skilled in the art without departing from the scope and spirit of this disclosure set forth in the claims.

What is claimed is:

1. A vapor chamber degassing tube structure, comprising:
a first plate, comprising a recess portion and a flange surrounding the recess portion, a receiving space defined on the recess portion, the flange comprising a first side facing a same direction as the receiving space and a second side opposite to the first side, and a tube connector disposed protrusively from the second side and located on the flange;
a second plate, covering the recess portion of the first plate, and connected with the flange; and
a degassing tube, disposed in the tube connector;
wherein a degassing opening is defined concavely on the first side and located on the tube connector, a maximum width of the degassing opening is defined in the tube connector and a minimum width of the degassing opening is defined on the first side, and the minimum width is less than the maximum width.

2. The vapor chamber degassing tube structure of claim 1, wherein a wick structure is disposed inside the first plate and the second plate.

3. The vapor chamber degassing tube structure of claim 1, wherein multiple support structures are disposed spacedly inside the first plate and the second plate.

4. The vapor chamber degassing tube structure of claim 1, wherein the recess portion is indented from the first side of the flange to define the receiving space.

5. The vapor chamber degassing tube structure of claim 1, wherein the second plate is a flat plate with a flat inner surface and a flat outer surface.

6. The vapor chamber degassing tube structure of claim 1, wherein the tube connector comprises two shrunk portions opposite to each other and disposed on the first side of the flange, and the minimum width is defined between the two shrunk portions.

7. The vapor chamber degassing tube structure of claim 1, wherein the maximum width is substantially matching with an outer diameter of the degassing tube.

8. A manufacturing method of a vapor chamber degassing tube structure, the manufacturing method comprising:
a) preparing a first plate with a degassing opening of a vapor chamber, wherein the first plate comprises a recess portion and a flange surrounding the recess portion, the flange comprises a first side and a second side opposite to the first side, and the degassing opening is formed on the flange and indented from the first side; and
b) using a mold to press the degassing opening located at a periphery of the flange to make the degassing opening taper toward the first side.

9. The manufacturing method of claim 8, further comprising c): inserting a degassing tube into the degassing opening in the b), and covering the second plate on the first plate.

10. The manufacturing method of claim 8, wherein the mold in the b) comprises two pressing mold blocks, and the two pressing mold blocks separately press the degassing opening at a periphery of the flange from two sides of the first plate.

11. The manufacturing method of claim 10, wherein the mold further comprises a support mold block, and the support mold block supports the flange of the first plate.
